(19) United States
(12) Patent Application Publication
(10) Pub. No.: US 2002/0006796 A1
(43) Pub. Date: Jan. 17, 2002

(54) PRIVATE TELECOMMUNICATIONS SWITCHING SYSTEM WITH SEVERAL RADIO BASE STATIONS

(76) Inventors: JEAN-RENE ROUSSEAU, NEUVILLE S/OISE (FR); ROLAND RIFF, STRASBOURG (FR); RICHARD GRUNER, SELESTAT (FR)

Correspondence Address: SUGHRUE MION ZINN MACPEAK & SEAS, 2100 PENNSYLVANIA AVNEUE N W, WASHINGTON, DC, 200373213

(21) Appl. No.: 09/270,513

(22) Filed: Mar. 17, 1999

(30) Foreign Application Priority Data
Mar. 18, 1998 (EP) 98440055.6

(51) Int. Cl. H04Q 7/20; H04B 7/00

(52) U.S. Cl. 455/436; 455/525

(57) ABSTRACT

Private telecommunications switching systems with several radio base stations are known. In private telecommunications switching systems based on the DECT (digitial enhanced cordless telephone) standard, each base station serves one cell. For an unambiguous association between the DECT system and the subscriber terminals, the base stations send out an access rights identifier (ARI) which can only be received and decoded correctly by authorized subscriber terminals. Since 8 bytes are reserved in the identifier for encoding the base-station numbers, a maximum of 256 base stations can be connected to a conventional DECT system.

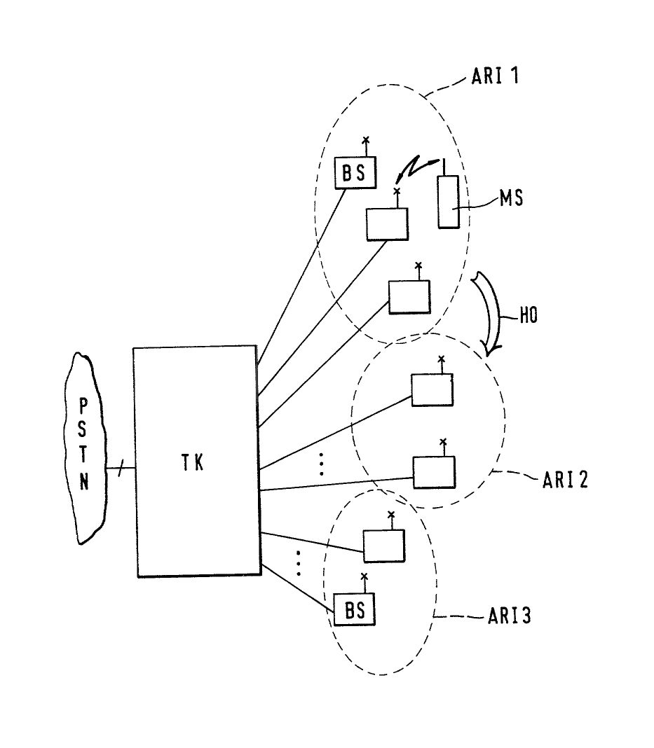

To be able to connect a substantially greater number of base stations, ideally an unlimited number, a private telecommunications switching system (TK) is proposed in which a first subset of base stations sends out a first identifier (ARI1), and in which at least a second subset of base stations sends out a second identifier (ARI2). The identifiers are received by the subscriber terminals (MS) to determine which subset of base stations serves the area in which the respective subscriber terminal currently is.

Private telecommunications switching systems serve to connect a number of subscribers to a telecommunications network. To provide wireless access to such a network, private telecommunications switching systems with several radio base stations are known which are connected with wireless subscriber terminals by radio links. For example, DECT (digital enhanced cordless telephone) systems are known in which each base station serves one cell. For an unambiguous association between the DECT system and the subscriber terminals, the base stations send out a so-called access rights identifier (ARI) which can only be received and decoded correctly by authorized subscriber terminals. In the DECT standard, 8 bytes are reserved in the ARI for encoding the base-station numbers. Accordingly, a maximum of 256 base stations can be connected to a conventional DECT system. It is desirable, however, to provide a private telecommunications switching system to which a significantly greater number of base stations, ideally an unlimited number, can be connected.

The invention proposes a private telecommunications switching system with several radio base stations for communication with wireless subscriber terminals wherein a first subset of radio base stations sends out a first identifier, and wherein at least a second subset of radio base stations sends out a second identifier, said first and second identifiers being received by the subscriber terminals to determine which subset of radio base stations serves the area in which the respective subscriber terminal currently is.

In this manner, a nearly arbitrary number of subsets can be formed which, in turn, may each contain as many base stations as a conventional private telecommunications switching system. With the proposed measure, the number of base stations is increased manifold, and use can be made largely of proven hardware and software, which preferably conforms to the DECT standard.

Advantageously, at least one of the wireless subscriber terminals does not contain all of the identifiers sent out by the base stations. In this manner, individual subscriber terminals can be denied access to all of the base stations, which permits a simple formation of closed user groups, for example.

The private telecommunications switching system advantageously includes control means which permit handoff of a subscriber terminal between two base stations transmitting different identifiers only if the two identifiers are stored in this subscriber terminal. This also makes it possible to fix boundaries in order to provide communications areas for subscribers.

The invention will become more apparent from the following description of an embodiment when taken in conjunction with the accompanying drawing.

The single figure of the drawing is a schematic representation of a private telecommunications switching system TK having several base stations BS connected to it. The base stations can communicate with wireless subscriber terminals. In the figure, one such wireless subscriber terminal MS is shown as an example.

The private telecommunications switching system TK, hereinafter referred to as the “system” for short, is connected to a telecommunications network, namely to the public telecommunications network PSTN (public switched telephone network).

The system TK establishes connections between one wireless subscriber terminal and another, or between the wireless subscriber terminals and terminals which are connected to the public telecommunications network PSTN.

The base stations BS connected to the system TK are assigned to several subsets, in this example three subsets. Each of these subsets is assigned an identifier which is sent out by the associated base stations. The base stations of the first subset send out a first identifier ARI1, those of the second subset send out a second identifier ARI2, and those of the third subset send out a third identifier ARI3. In this example, each base station is assigned to only one of the three subsets.

Each identifier, e.g., ARI1, contains an 8-byte data field for entering base-station numbers. This means that each, of these three subsets may contain up to 256 base stations. The system TK can thus be connected with up to 768 base stations BS, so that it can serve a very large area.

The subscriber terminal MS shown in the figure contains all three identifiers ARI1 to ARI3, so that on receipt of an identifier it can determine in which subset it currently is. Having all of the identifiers ARI1 to ARI3, the subscriber terminal MS can communicate with all base stations BS and change between the different areas. It is also possible to store only one or few identifiers in a subscriber terminal, so that the latter is authorized to communicate with the respective base stations in only one or few areas.

The proposed system TK is particularly suited for serving the various areas of a major company site. Each area will be assigned a given identifier, each area being subdivided into cells each served by a respective one of the base stations BS.

The system TK further includes control means for handing off a call from one cell to another. In the figure, handoff HO from the area with the first identifier ARI1 to the area with the second identifier ARI2 is indicated symbolically. When a subscriber terminal leaves one area and enters another, the decision on the instant of handoff is made on the basis of signal quality. This means, for example, that the received field strengths on the radio links to the old and new base stations are measured. Another criterion is the signal-to-noice ratio, for example.

Since several identifiers ARI1 to ARI3 are used, the system TK can determine at any time in which of the various areas the subscriber terminal MS currently is. The tracking of mobile subscriber terminals can also be utilized to initiate alarm messages if someone removes a subscriber terminal from an area or takes it to a new area without authority.

The invention described relates to a system to which remote base stations are connected. It is also possible to integrate the base stations, in whole or in part, into the system. For example, signal processing stages, such as a modulation stage and a demodulation stage, may be incorporated into the system, leaving only the radio-frequency stage, preferably the RF amplifier and the antenna, in the remote base station. In this connection it is advantageous if the remote RF units of the base stations are connected to the system by optical fibers. In that case, the system can itself generate RF signals and distribute them over the optical fibers to the remote RF units.

1. A private telecommunications switching system (TK) with several radio base stations (BS) for communication with wireless subscriber terminals (MS) wherein a first subset of radio base stations (BS) sends out a first identifier (ARI1), and wherein at least a second subset of radio base stations (BS) sends out a second identifier (ARI2), said first and second identifiers (ARI1, ARI2) being received by the subscriber terminals (MS) to determine which subset of radio base stations (BS) serves the area in which the respective subscriber terminal (MS) currently is:

2. A private telecommunications switching system (TK) as claimed in claim 1 wherein each radio base station is assigned to only one subset, and wherein only this subset sends out a corresponding identifier.

3. A private telecommunications switching system (TK) as claimed in claim 1 wherein all of the identifiers (ARI1, ARI2, ARI3) sent out by the radio base stations (BS) are stored in each wireless subscriber terminal (MS).

4. A private telecommunications switching system (TK) as claimed in claim 1 wherein not all of the identifiers sent out by the radio base stations are stored in at least one of the wireless subscriber terminals.

5. A private telecommunications switching system (TK) as claimed in claim 1 wherein each radio base station (BS) serves one cell, and which includes control means for handing off (HO) a call from one cell to the next.

6. A private telecommunications switching system (TK) as claimed in claim 5 wherein the change (HO) of a subscriber terminal (MS) between two radio base stations (BS) which send out different identifiers (ARI1, ARI2) is permitted by the control means only if said two different identifiers (ARI1, ARI2) are stored in the subscriber terminal (MS).
